(19) United States
(12) Patent Application Publication
(10) Pub. No.: US 2017/0098036 A1
(43) Pub. Date: Apr. 6, 2017

(54) METHOD OF MANAGING PATIENT INFORMATION AND DISTRIBUTION TO SPECIFIC USERS

(71) Applicant: HPC, LLC, Mobile, AL (US)

(72) Inventor: Ronald Jay Cieutat, Mobile, AL (US)

(21) Appl. No.: 14/875,371

(22) Filed: Oct. 5, 2015

(51) Int. Cl. G06F 19/00

(52) U.S. Cl. CPC G06F 19/322

(57) ABSTRACT

A system and method for managing and distributing digital patient medical files via a web portal is provided. Computer systems are programmed to allow a plurality of system administrators to upload, edit, manage, and selectively distribute files containing patient medical information to authorized users of the system. An administrator, which is typically a doctor or other health care professional, can restrict access to a patient's information depending on the need of the user to view particular information.

### FIELD OF THE INVENTION

The present invention refers generally to a method and system supporting patient information collaboration and distribution. More specifically, the invention relates to a system and method for specific parties to access a specific patient's care information in a context sensitive, secure manner.

### BACKGROUND

It is extremely important for doctors and physicians to have quick and easy access to all of a patient's medical records in one place. However, because a patient may see a number of different medical practitioners, including a general practitioner as well as specialists, over extended periods of time covering the patient's medical history, these records are typically found in many different locations and are not compiled in one convenient location. Having these records easily available in one location would provide a doctor with a patient's complete medical history and allow the doctor to provide better patient care. It would also alert a doctor to potential issues the patient may have so that the doctor can discuss the issue with another of the patient's doctors if necessary. Furthermore, the doctor would be able to monitor the overall health of a patient or the progress of a patient recovering from a specific medical condition with the confidence of knowing that the doctor has all of the available and relevant medical records.

In addition, other third parties may need to view a patient's medical records. For instance, caregivers or concerned family members could view the medical records of an elderly patient. Other interested parties who may need to view such records include pharmacists and insurance companies. However, some third parties may need access only to certain portions of a patient's medical records, and the patient may want to limit access to such records by selecting only certain portions of the medical records for review. This may be difficult to do, though, because a blanket authorization allows the authorized party to view more of the patient's medical records than necessary or desired.

Some known systems are used for storing patient information relating to patient medications, but these systems do not allow a party to view a comprehensive record of a patient's medical history. In addition, known systems for storing patient records do not allow the patient or the patient's doctor to selectively limit the records that are viewable by an authorized third party.

Therefore, a need exists in the art for a patient data management system and method for storing and managing patient medical records. Furthermore, a need exists in the art for a patient data management system that allows an administrator to selectively distribute patient information to authorized users.

### SUMMARY

The present invention relates to a system and a method for storing and managing patient medical records and selectively distributing patient medical information to one or more authorized users. The patient information is stored in electronic computer files, which may include, but are not limited to, word processor files, spreadsheet files, digital image or video files, or any similar file providing health information concerning a patient.

In accordance with an implementation of the invention, computer applications are programmed to provide an internet-based web portal, which provides selective access to one or more patient databases storing a plurality of files each containing health information related to a patient. The system is configured to allow administrators of the system to create new patient files by inputting patient information. In one embodiment, the patient information can be input by uploading an existing file containing patient information. For instance, the existing file could be a word processing file containing a doctor's notes or test results, a scanned copy of such a document, an image file showing an x-ray image, or any similar document containing health information. In addition, computer applications are programmed to allow an administrator to directly input new patient information through the system of the present invention, thereby creating new files for new or existing patients. In one embodiment, a computer application prompts an administrator to answer a question having multiple pre-determined answers. The application may also provide data input fields in which an administrator can directly input patient data. The application provides the administrator with an option to save information that has been entered, thereby creating a new file. Administrators may also be able to edit or update patient information saved in the system by adding, deleting, or changing information. For instance, an administrator may add new notes to a patient's records that provide an update to the patient's progress with respect to a particular health issue. The system may be customized for certain types of doctors who commonly deal with certain types of medical conditions.

Administrators are typically doctors, physicians, or other health professionals qualified to manage a patient's health records or otherwise having the authority to manage patients' health records. Furthermore, computer applications are programmed to provide administrators with the ability to add users to the system by authorizing new user accounts and to control what medical records or other patient information that a particular authorized user may view using the system. Authorized users may include the patient to whom the particular medical records relate, other doctors or physicians who are not administrators, pharmacists, insurance company representatives, caregivers, or other concerned parties such as family members. Authorized users may be granted access to the system as individual users or as part of a user group. For instance, multiple representatives working for a health insurance provider may be part of a user group. Each user or user group has access to particular medical records or other health information based on need. Thus, an administrator can authorize users or user groups to view patient information contained within the database and also select which files or information each user or user group has access to.

In another embodiment, computer applications are programmed to create a profile for a particular patient and to provide authorized users the ability to add private or public (i.e., viewable by all authorized users and administrators) comments or questions to the patient profile. Thus, for instance, a patient or concerned family member can ask a doctor/administrator a question or report new symptoms of a medical condition or side effects of a prescribed medication. Similarly, two different doctors who are both treating a patient can use the system to communicate with each other and follow the progress of a patient. Other uses, for instance, may include insurance providers communicating with a doctor/administrator regarding information relevant to insurance coverage. Similar to patient files stored in the system, an administrator has the ability to select which authorized users can view and/or add comments or questions to a patient profile.

All of a patient's medical information over the course of the patient's life can be stored and updated in a single location, and all of this information is accessible via a web portal. Such a system is advantageous because it keeps a complete medical history of a patient, including all medications that the patient is currently or has ever taken. The system may also provide other relevant health information such as any allergies a patient has with respect to particular medications. This information may be particularly useful to medical personnel in emergency situations. Accordingly, the system is also programmed to provide any medical information relevant in an emergency situation to authorized emergency medical personnel.

### DESCRIPTION OF THE DRAWINGS

These and other features, aspects, and advantages of the present invention will become better understood with regard to the following description, appended claims, and accompanying drawings where:

FIG. 1 is a system diagram illustrating an apparatus and system for managing and distributing patient files for viewing by a plurality of authorized users.

FIG. 2 is a system diagram illustrating an apparatus and system for managing and distributing patient files for viewing by a plurality of authorized users.

FIG. 3 is a system diagram illustrating an apparatus and system for managing and distributing patient files for viewing by a plurality of authorized users.

FIG. 4 illustrates a method of an administrator creating, managing, and controlling access to patient files for viewing by a plurality of authorized users.

FIG. 5 illustrates a method of an authorized user using a web portal to view patient files to which the authorized user has been granted access.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with or in the context of other particular aspects of the embodiments of the invention, and in the invention generally.

The term “comprises” and grammatical equivalents thereof are used herein to mean that other components, steps, etc. are optionally present. For example, an article “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

In the following detailed description, reference is made to the accompanying drawings that form a part hereof, and in which is shown by way of illustration specific embodiments in which the subject matter can be practiced. These embodiments are described in sufficient detail to enable those skilled in the art to practice them, and it is to be understood that other embodiments can be utilized and that structural, logical, and electrical changes can be made without departing from the scope of the inventive subject matter. Such embodiments of the inventive subject matter can be referred to, individually and/or collectively, herein by the term “invention” merely for convenience and without intending to voluntarily limit the scope of this application to any single invention or inventive concept if more than one is in fact disclosed. The following description is, therefore, not to be taken in a limited sense.

The embodiments of the systems and methods described herein may be implemented in hardware or software, or a combination of both. For example, some embodiments may be implemented in computer systems and computer programs, which may be stored on a physical computer-readable medium, executable on programmable computers each comprising at least one processor, a data storage system (including volatile and non-volatile memory and/or storage elements), at least one input device (e.g. a keyboard or mouse), and at least one output device (e.g. a display screen, a network, or a remote server). For example and without limitation, the programmable computers may include personal computers, laptops, netbook computers, personal data assistants (PDA), cell phones, smart phones, smart cameras, gaming devices, and other mobile devices.

In accordance with the present invention, a system and a method for managing and distributing patient information are provided. The system is configured to allow administrators of the system to manage and distribute patient information to authorized users of the system. Authorized users access the patient information via an internet-based web portal, which provides selective access to one or more patient databases storing patient files containing patient data or other health information related to a patient. Administrators of the system typically include, but are not limited to, doctors, physicians, or other health care professionals qualified to manage a patient's health records or otherwise having the authority to manage patients' health records. Authorized users are any users of the system having access, which is granted by at least one administrator, to all or part of at least one patient's medical records. Authorized users typically include, but are not limited to, patients, other doctors or physicians who are not administrators, pharmacists, insurance company representatives, caregivers, or other concerned parties such as family members of a patient. Authorized users may be granted access to the system as individual users or as part of a user group. For instance, multiple representatives working for a health insurance provider may be part of a user group. Each user or user group has access to particular medical records or other health information based on need. Thus, the system is configured to allow an administrator to create user accounts for authorized users and grant access to the system to those authorized users. The administrator can then authorize particular users or user groups to view patient files in the database and also select which files or information each user or user group has access to. Each administrator has control over medical files associated with a patient and has the authority to grant access to those files under the administrator's control. However, one administrator cannot grant access to a patient file under the control of a second administrator without the authorization of the second administrator. Because administrators are typically doctors or other health professionals, there are generally many administrators utilizing the system.

The system is further configured to allow super administrators, which are typically not doctors or health professionals directly involved with patient care, to create administrator accounts. Super administrators have access to all files in the system. Using an administrator account, each administrator can then begin adding patient files to the system and authorizing specific users to view those files. Thus, the system of the present invention has a three-tiered hierarchy of super administrators, administrators, and authorized users.

As used herein, the terms “health information”, “patient information”, “medical information”, “medical records”, “patient files”, or similar terms, refer to any data or other information stored in any electronic form that relates in any way to the health or physical or mental condition of a patient. Such information may be stored in any type of electronic computer file, which may include, but are not limited to, word processor files, PDF files, spreadsheet files, digital image or video files, or any similar file providing an indication of the health or physical or mental condition of a patient. For instance, patient files may include a word processing file or spreadsheet file containing a doctor's notes or test results, a scanned copy of such a document, or an image file showing an x-ray image, among other examples.

The system of the present invention allows administrators to both manage and distribute a patient's medical information to one or more authorized users. As used herein, managing medical information refers to adding, deleting, editing, and/or providing access to any information that pertains to a patient's health and is stored in a database in the system of the present invention. As used herein, distributing medical information refers to selectively granting access to any part of a patient's medical records or all of a patient's medical records to one or more users or user groups.

The system comprises at least one computer application comprising computer executable code stored on computer-readable medium. The code is executed by a plurality of computing devices, which may include laptops, personal computers, smart phones, or any similar computing devices capable of communicating with a network. The computing devices communicate with at least one server via a communications network. The server also communicates with at least one database, which is used to store a plurality of computer files, each file containing health information associated with a particular patient.

In accordance with the present invention, a system and a method for managing and distributing patient medical information are provided. Authorized users of the system access the information via a web portal. The system is configured to allow administrators to create new patient files by inputting patient information. Patient information can be input either by uploading an existing file containing patient information to the system or, alternatively, by directly inputting new patient information through a programmed computer application functioning as part of the system of the present invention. In one embodiment, a computer application prompts an administrator to answer a question having multiple pre-determined answers. The application may also provide data input fields in which an administrator can directly input patient data. The application provides the administrator with an option to save information that has been entered, thereby creating a new file. Administrators may also be able to edit or update patient information saved in the system by adding, deleting, or changing information. For instance, an administrator may add new notes to a patient's records that provide an update to the patient's progress with respect to a particular health issue. The system may be customized for certain types of doctors who commonly deal with certain types of medical conditions.

This patient information is then stored in a patient database that stores the health records of a plurality of patients. Each patient file stored in a system database is associated with a specific patient. Computer applications are programmed to provide administrators with the ability to add authorized users to the system by authorizing new user accounts and new user groups of authorized users. Administrators can also control which patient files that a particular authorized user or group of authorized users may view using the system. Access to particular patient files can be determined on a case-by-case basis according to the need of each user or group of users. For instance, a pharmacist may need to view information related to current medications that a patient is taking but may not need to view a complete medical history or other information related to a specific condition or health issue the patient may have. The administrator for that patient's files, which is typically one of the patient's doctors, may grant access to a particular pharmacist, or to a user group comprising more than one pharmacists that the patient has used before, to view any of the patient's files related to medications, but limit the access to only those files related to medications. Similarly, one or more representatives of a health insurance company may need to view a patient's files relating to a specific health issue for purposes of insurance coverage but may not need to view records relating to medications or other health issues of the patient. In this case, the administrator may once again grant access to a particular representative, or to a user group comprising more than one representative of the same or a different insurance company, to view any of the patient's files related only to that specific health issue.

A single patient may have medical files under the control of one administrator and other files under the control of another administrator. The system does not limit the number of administrators that may have control of files related to one patient. For instance, a patient may have one primary care physician and one or more specialists that the patient sees for specific health issues. Each of these doctors may create his or her own files for the patient and would be an administrator of those files. In one embodiment, one doctor/administrator would require authorization from a second doctor/administrator in order to view files under the control of the second doctor/administrator. In a preferred embodiment, the system is configured such that any administrator of a patient's files may view files under the control of any other administrator. Alternatively, any administrator may simply provide a blanket authorization to all other administrators of one or more files associated with a particular patient to view that patient's files.

In another embodiment, computer applications are further programmed to create a profile for a particular patient and to provide authorized users the ability to add private or public (i.e., viewable by all authorized users and administrators) comments or questions to the patient profile. Thus, for instance, a patient or concerned family member can ask a doctor/administrator a question or report new symptoms of a medical condition or side effects of a prescribed medication. Similarly, two different doctors who are both treating a patient can use the system to communicate with each other and follow the progress of a patient. Other uses, for instance, may include insurance providers communicating with a doctor/administrator regarding information relevant to insurance coverage. Similar to patient files, an administrator has the ability to select which authorized users can view and/or add comments or questions to a patient profile. The patient profile is preferably viewable as a web page accessible by both administrators and authorized users after logging into the system. The web page provides an option for authorized users to send a private message to one or more administrators of the patient's files or for one administrator to send a private message to one or more other administrators of the patient's files. Thus, the profile web page allows open communication between relevant parties regarding a patient's health or related issues such as insurance coverage issues. The system saves all messages so that there is a permanent record of all communications regarding each patient in the system.

All of a patient's medical information over the course of the patient's life is thus stored and updated in a single location, and all of this information is accessible via a web portal. Such a system is advantageous because it keeps a complete medical history of a patient, including all medications that the patient is currently or has ever taken, and this information is easily and readily available to a patient's doctor in one convenient location. The information is stored in a system database and backed up regularly. Thus, there is never an issue of lost medical records or an incomplete medical history. In addition, there is no need for doctors or hospitals to transfer patient files to other doctors or hospitals if a patient moves to a new city or if a patient goes to a new doctor or hospital for other treatment. The medical history is stored electronically on a system database and simply follows the patient. Every file is associated with a particular patient by a patient identifier, which is preferably a patient identification number assigned to each patient as he or she is first entered into the system. Every time a new file is added to the system, a patient identifier is added to that file so that a set of patient files is collected for each patient.

In a preferred embodiment, the patient files comprise one or more files designated as emergency-relevant files. These files may contain any relevant health information such as any allergies a patient has with respect to particular medications, or any other information that may be particularly relevant to medical personnel in an emergency situation. Emergency room doctors or other health care professionals who are likely to administer care during an emergency situation, such as emergency medical technicians (EMTs), may be authorized to access any patient files in the system that are designated as emergency-relevant files. Thus, during an emergency medical situation, the system may quickly provide potentially life-saving information to doctors or other emergency personnel by simply having the doctor enter the patient's identification number into an application on a computing device such as a computer, laptop, or smart phone. Thus, emergency personnel are simply a specific type of authorized user having access only to patient files designated as emergency-relevant files.

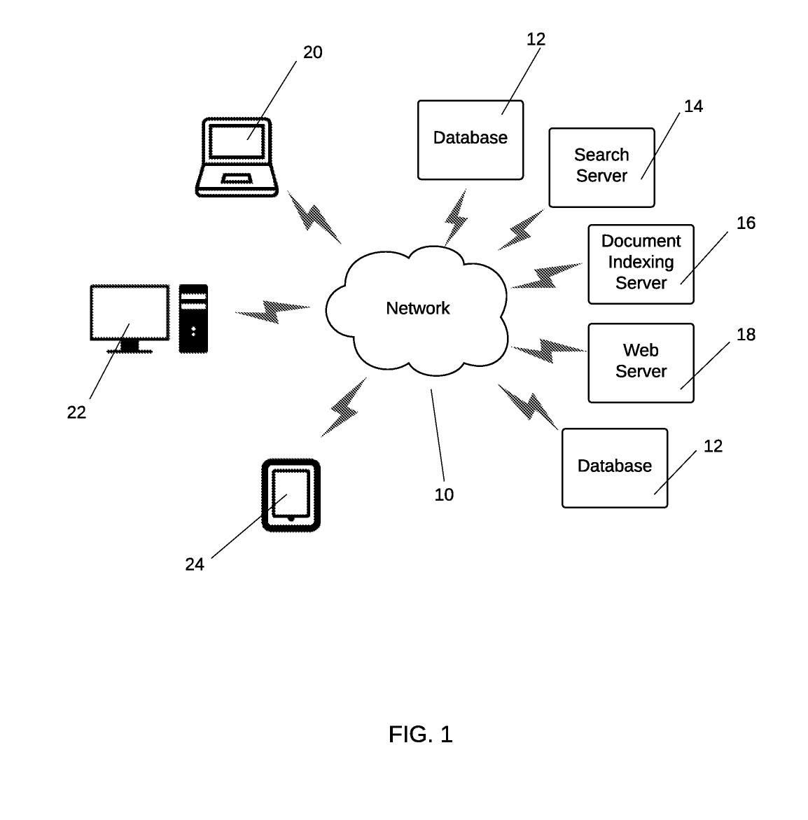

Turning now to the drawings, FIGS. 1-5 illustrate preferred embodiments of the present invention. FIG. 1 is an exemplary diagram of a network 10 in which systems and methods consistent with the principles of the invention may be implemented. The network 10 may include multiple clients 20, 22, 24 connected to multiple servers 14, 16, 18 via a network, which may include one or more networks of any kind, including, but not limited to, a local area network (LAN), a wide area network (WAN), a telephone network, such as the Public Switched Telephone Network (PTSN), an intranet, the Internet, a memory device, another type of network, or a combination of networks. Three clients 20, 22, 24, three servers 14, 16, 18, and two databases 12 have been illustrated as connected to the network for simplicity. In practice, there may be more or fewer clients, servers, and databases.

Clients may include devices of authorized users that access servers. A client may include, for instance, a laptop 20, a personal computer 22, a smart phone 24, or any similar computing device including, but not limited to, a wireless telephone, a personal digital assistant (PDA), a tablet computer, a smart camera, or another type of computation or communication device.

Servers may include devices that access, fetch, aggregate, process, search, provide, and/or maintain documents. Although shown as single components in FIG. 1, each server may, in some implementations, be implemented as multiple computing devices, which potentially may be geographically distributed. One or more search servers 14 may include one or more computing devices designed to implement a search engine, such as a documents/records search engine, general webpage search engine, etc. Search servers may, for example, include one or more web servers to receive search queries and/or inputs from clients, search one or more databases in response to the search queries and/or inputs, and provide documents, relevant to the search queries and/or inputs, to clients. In some implementations, the search server 14 may include a web search server that may provide webpages to clients, where a provided webpage may include a reference to a web server at which the desired information is located and other information and/or links. The references, to the web server at which the desired information is located, may be included in a frame and/or text box, or as a link to the desired information/document.

One or more document indexing servers 16 may include one or more computing devices designed to index documents available through the network 10. The document indexing server 16 may access other servers, such as web servers that host content, to index the content. In some implementations, the document indexing server may index documents/records stored by other servers, such as web servers, connected to the network. The document indexing server may, for example, store and index content, information, and documents relating to a user's stored documents, videos, and images.

One or more web servers 18 may each include web servers that provide webpages to clients. The webpages may be, for example, HTML-based webpages. A web server may host one or more websites. A website, as the term is used herein, may refer to a collection of related webpages. Frequently, a website may be associated with a single domain name, although some website may potentially encompass more than one domain name. The concepts described herein may be applied on a per-website basis. Alternatively, in some implementations, the concepts described herein may be applied on a per-webpage basis.

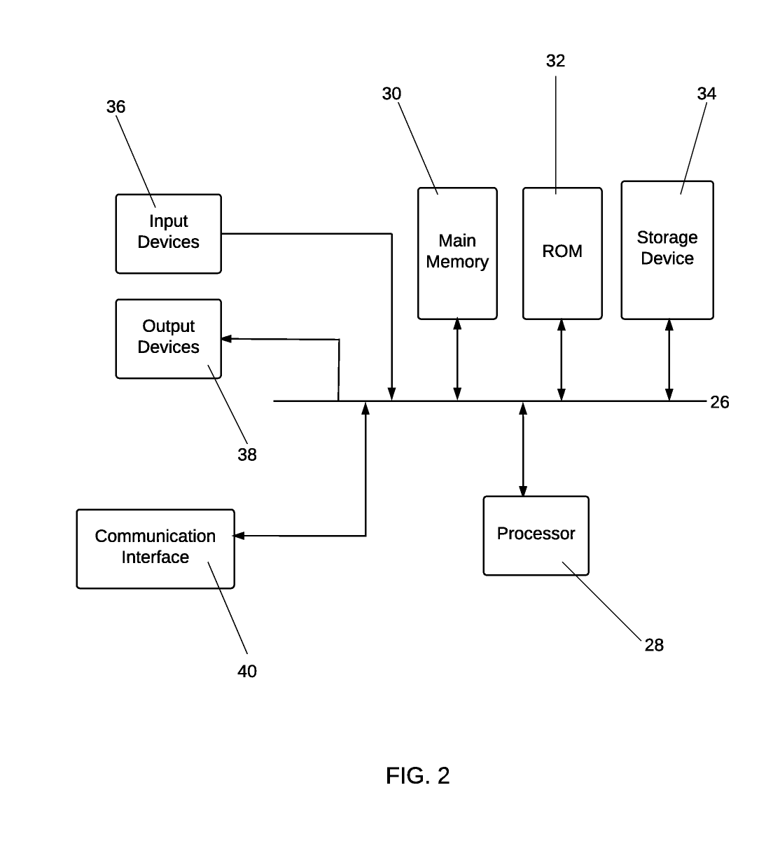

FIG. 2 is an exemplary diagram of a client or server entity (hereinafter called “client/server entity”), which may correspond to one or more of the clients and servers, according to an implementation consistent with the principles of the invention. The client/server entity may include a bus 26, a processor 28, a main memory 30, a read only memory (ROM) 32, a storage device 34, one or more input devices 36, one or more output devices 38, and a communication interface 40. The bus 26 may include one or more conductors that permit communication among the components of the client/server entity.

The processor 28 may include any type of conventional processor or microprocessor that interprets and executes instructions. The main memory 30 may include a random access memory (RAM) or another type of dynamic storage device that stores information and instructions for execution by a processor. The ROM 32 may include a conventional ROM device or another type of static storage device that stores static information and instructions for use by a processor. The storage device 34 may include a magnetic and/or optical recording medium and its corresponding drive.

Input devices 36 may include one or more conventional mechanisms that permit an operator to input information to the client/server entity, such as a keyboard, a mouse, a pen, voice recognition and/or biometric mechanisms, etc. Output devices 38 may include one or more conventional mechanisms that output information to the operator, including a display, a printer, a speaker, etc. Communication interface 40 may include any transceiver-like mechanism that enables the client/server entity to communicate with other devices and/or systems. For example, communication interface may include mechanisms for communicating with another device or system via a network, such as the network 10 illustrated in FIG. 1.

As will be described in detail below, the client/server entity, consistent with the principles of the invention, performs certain search-related and verification-related operations. The client/server entity may perform these operations in response to processor 28 executing software instructions contained in a computer-readable medium, such as memory. A computer-readable medium may be defined as one or more physical or logical memory devices and/or carrier waves.

The software instructions may be read into memory from another computer-readable medium, such as a data storage device 34, or from another device via a communication interface 40. The software instructions contained in memory causes the processor 28 to perform processes that will be described later. Alternatively, hardwired circuitry may be used in place of or in combination with software instructions to implement processes consistent with the principles of the invention. Thus, implementations consistent with the principles of the invention are not limited to any specific combination of hardware circuitry and software.

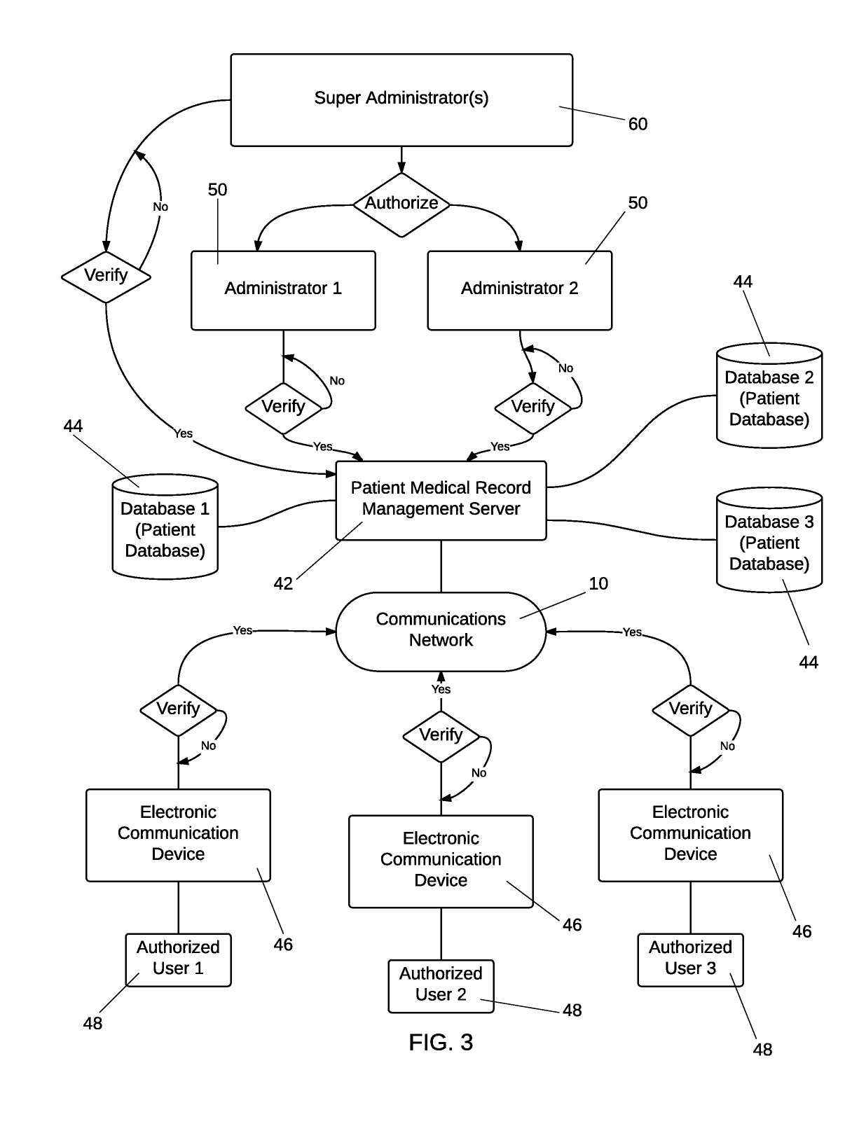

FIGS. 3-5 illustrate flowcharts of exemplary processing for managing and distributing patient medical information according to an implementation consistent with the principles of the invention. In one implementation, there is provided a system comprising a method of managing and distributing a plurality of patient files that authorized users of the system may view through a web portal. The example embodiment provides methods and computer systems programmed to use a software application, method, and apparatus for storing, organizing, managing, and distributing patient files associated with a plurality of individual patients. In addition, a preferred embodiment provides methods and computer systems for interacting and communicating with the software application, method, and apparatus. The separate method and computer system components making up the present invention are collectively referred to as the “Patient Medical Record Management” system, method, and apparatus.

In a preferred embodiment, the software application provides a system and a method for uploading and managing a plurality of patient files and granting access to those files to authorized users of the system. In a one implementation, an administrator 50 uses a web browser to access an admin website, or application. From this website or application, the administrator can upload patient files, edit patient files or other patient information, assign a patient identification number to individual files or groups of files, categorize files or groups of files according to a label or numeric identifier, create authorized user accounts, and grant access to authorized users to view specific patient files based on a patient identification number and, optionally, also based on a specific category of files, if desired. Authorized users 48 of the system may then use a web browser or application to access a web portal that allows authorized users to view any patient files that the user is authorized to view simply by entering a patient identification number associated with a particular patient.

FIG. 3 illustrates a preferred implementation of an embodiment of the Patient Medical Record Management system. In this embodiment, the system comprises a data processor and memory programmed to receive and store digital files of various types. In an example embodiment, a Patient Medical Record Management server 42, which may be referred to as a data management server, comprises at least one database 44 containing patient files. The one or more databases 44 store digital patient files each associated with a particular patient. Each patient file stored in the database 44 is tagged with a patient identifier such as a patient identification number that associates the file with a particular patient. Each file may then be tagged by an administrator 50 with one or more optional sub-identifiers, such as a label, a numeric identifier, or any similar identifier, so that each file may be placed into sub-categories. An administrator having control of a patient's files may then use the patient identifiers and any sub-identifiers to restrict access to the files by authorized users 48. For instance, one authorized user may have access to all files tagged with a particular patient identification number, regardless of whether any sub-identifiers are attached to the files. However, another authorized user may have access to only certain files tagged with one or more specific sub-identifiers. Yet another authorized user may have access to a different set of files tagged with one or more different sub-identifiers. Thus, each administrator 50 has a plurality of files under his control relating to a plurality of patients, and each administrator can customize which authorized users may view which files.

An authorized user 48 may access patient files stored in the one or more databases 44 only after the authorized user's identity has been verified. This verification step may be by password, passcode, or equivalent means. In on implementation, an authorized user 48 logs into a web page and enters a unique username and password. If the authorized user 48 is using the software application for the first time, the authorized user will first establish a new authorized user account. The application will prompt the authorized user 48 to input personal information verifying the user's identity. For instance, the application may require the authorized user 48 to enter an email address and password. However, before an authorized user 48 can create an account, the user must be authorized to do so by an administrator 50. An administrator may authorize a user account and then send the user an email inviting the user to create an account. The email may contain a code for the user to input when creating an account to verify the identity of the user, or the email may contain a link directly to a web page for setting up an authorized user account. The link may expire after a set period of time.

Once the authorized user's identity has been verified, the authorized user 48 may then access the patient files that the user is authorized to access via a communications network 10. The network 10 may be a wired or wireless network and may provide access to the database 44 via the internet or an intranet. In a preferred embodiment, the communications network 10 of the present invention is connected to the internet, thus allowing all authorized users 48 to access and view patient files through a website, an application, or equivalent viewing means.

One or more super administrators 60 of the overall Patient Medical Record Management server has access to all files stored on all databases 44 upon verification of the identity of each super administrator 60. This verification step may be by password, passcode, or equivalent means. Super administrators 60 of the overall system have access to all patient files in the system. Super administrators 60 are also responsible for authorizing each administrator 50 using the system. Once an administrator 50 has been authorized, the administrator can then begin adding new patients to the system and managing those patients' medical files. Each administrator has full control over the patient files associated with any patient that the administrator adds to the system. However, one administrator will not automatically have access to the files of a patient added to the system by a second administrator. In that case, the second administrator will have to authorize the first administrator to view specific patient files or, optionally, provide the first administrator with a blanket authorization to view all files within the control of the second administrator.

In a preferred embodiment, access to the system is completely private and secure. Incorporating security features currently known in the art may accomplish this. Thus, any files shared by administrators 50 of the system or viewed by authorized users 48 of the system will never be transferred to unauthorized third parties.

In a preferred embodiment, an authorized user 48 will access the Patient Medical Record Management server 42 by using an electronic communication device 46, which will access the system through a web application interface or similar type of software application. In a preferred implementation, an authorized user 48 will access the web page/application via a web browser. The authorized user's electronic communication device 46 may be any computing device such as a laptop 20, personal computer 22, smart phone 24, electronic tablet, PDA, smart digital camera, or similar device.

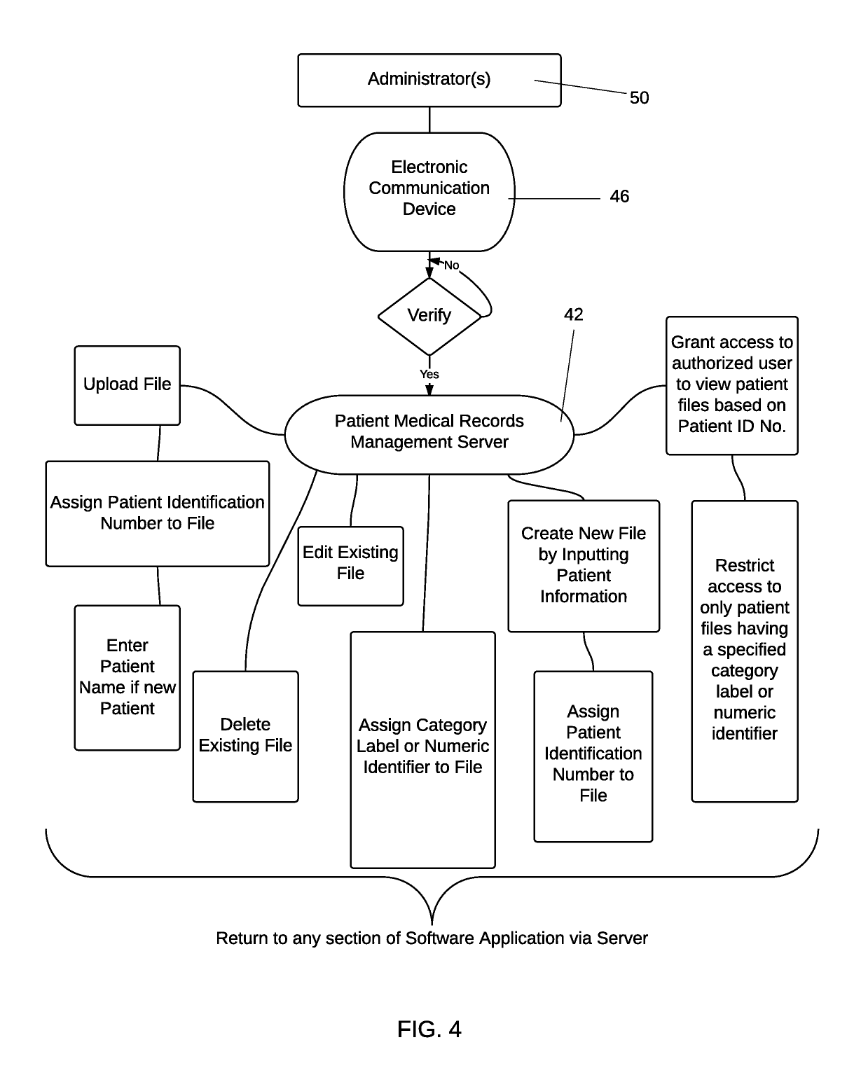

FIG. 4 illustrates a process of using a software application for managing and distributing patient medical files. In a preferred embodiment, an administrator 50 will use an electronic communication device 46 to access the communications network 10 through a web-based software application. Once the administrator's identity is verified, the administrator 50 may then use the application to upload one or more patient files or engage in other actions related to the management or distribution of patient files.

For instance, the software application allows an administrator 50 to upload patient files for viewing by authorized users 48. The types of digital patient files that may be utilized with the present invention include, but are not limited to, word processor files, spreadsheet files, scanned copies of such documents, PDF files, and digital image or video files. When a file is uploaded, the administrator 50 also assigns a patient identification number to each uploaded file. If the patient is a new patient, the administrator will also enter the patient's name, and all future files assigned that identification number that are added to the system will be associated with that patient. Optionally, the administrator may also categorize one or more uploaded files by assigning a sub-identifier such as a label (e.g., “blood pressure files”, “dental files”, “medication files”, or similar labels) or a separate numeric identifier. Such sub-labels may be added as file identifiers at any later time and are used to restrict authorized users to viewing only certain categories of patient files.

The application also allows an administrator 50 to create a new patient file by directly inputting new patient information through a programmed computer application functioning as part of the system of the present invention. For instance, the application may prompt the administrator to enter patient information into input fields. Exemplary information may include the patient's name, height, weight, blood pressure, or similar information. Other input fields may allow the administrator to enter notes or any other personalized information regarding the patient. In another embodiment, the application may prompt the administrator to answer a question having multiple pre-determined answers, which may, for instance, include yes/no questions regarding a variety of medical conditions or symptoms experienced by the patient. The application may be customized by changing the input fields for certain types of doctors who commonly deal with certain types of medical conditions. The application provides the administrator with an option to save information that has been entered, thereby creating a new file. Administrators may also be able to edit or update patient information saved in the system by adding, deleting, or changing information contained in this type of patient file created by an administrator. For instance, an administrator may add new notes to a patient's records that provide an update to the patient's progress with respect to a particular health issue. Patient files may also be deleted from the system if the administrator determines that the files are no longer needed or the information contained therein is now inaccurate, though any deleted files are preferably backed up so that they can be recovered at a later time if necessary.

The application also allows an administrator 50 to grant and restrict access to patient files by authorized users 48. For example, a doctor/administrator may wish to grant access to a pharmacist/authorized user to view one or more files regarding medication that a patient is currently taking The doctor may wish to restrict the pharmacist's viewing to only these files and not allow the pharmacist to view all of the patient's medical files. In this case, the doctor would assign the patient's identification number to the relevant files and also a label, such as “medication files.” The doctor would then send an invitation by email to the pharmacist with a code or a link that allows the pharmacist to create a new authorized user account. The doctor, as an administrator, would login to an administrator account that lists all authorized users that the doctor has authorized. The doctor would then select the pharmacist and enter the patient identification number and the file label (in this case, “medication files”), which would restrict the pharmacist to viewing only those files. If other patients of the doctor use the same pharmacist, the doctor may allow that pharmacist to view the relevant files for each of those patients, as well. To simplify the process, the doctor may include both the patient's name as well as the patient identification number on any prescription sent to that pharmacist so that the pharmacist is alerted that he has the capability of viewing that patient's files using the web portal system. The pharmacist could then enter the patient's name or identification number into the system, and the system would then provide only those files that the doctor has authorized the pharmacist to view.

Following any of the above actions taken by an administrator, the software application will present the administrator with the option of returning to any section of the application associated with any of the actions illustrated in FIG. 4.

An administrator 50 of the system interacts with the software application shown in FIG. 4 using some type of electronic communication device 46, e.g., a laptop 20, a personal computer 22, or a smart phone 24, in communication with the network 10. This interaction typically takes place using a web browser, which includes menus and buttons for navigating through the functions of the software application. For instance, the application will have a homepage viewable in the web browser. The homepage may have a dropdown menu listing actions that can be taken, or it may have buttons associated with each of the actions illustrated in FIG. 4. The administrator may then select a desired action using an input device 36 such as a mouse or a touch screen.

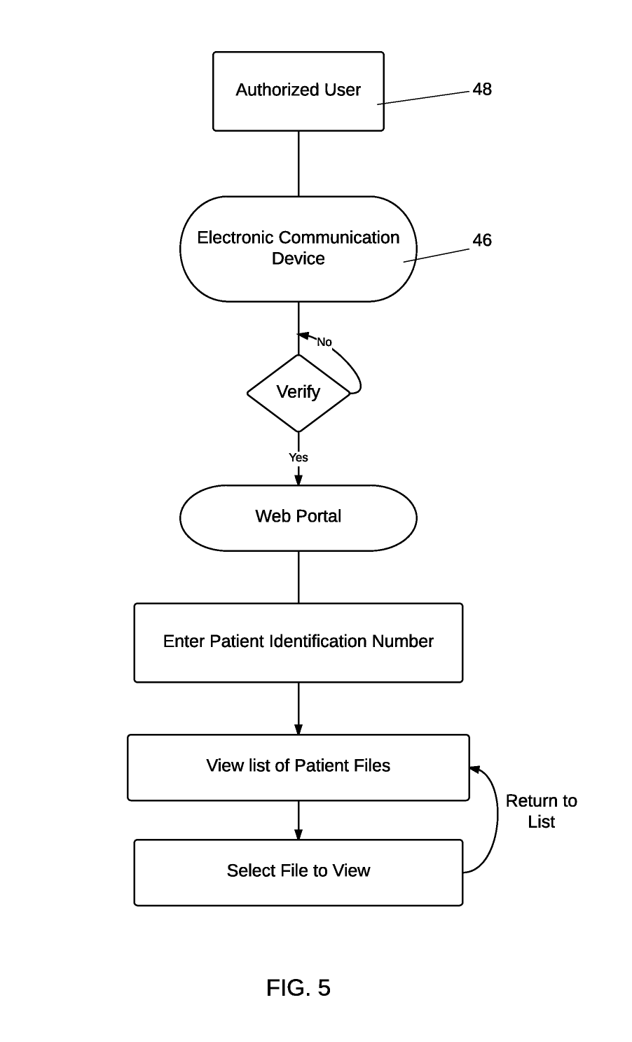

As set forth in FIG. 5, an authorized user 48 will use a web browser or application on an electronic communication device 46 to access the web portal for viewing patient files. If it is the first time that the user 48 is accessing the web portal, the user will be prompted to create a new authorized user account, which may require the user to enter a code supplied by an administrator 50 to verify the identity of the user. Once an authorized user account has been created, the user may access the web portal by providing a username and password or a similar means for identifying the user. Once an authorized user 48 has accessed the web portal, the user will be prompted to provide a patient name or identification number. Preferably, the authorized user will provide a patient identification number because it is a unique number. If the user enters a patient name and there is more than one patient with that name, then the application will provide a list of patients to choose from. If the authorized user selects a patient whose files the user has not been granted access to, then the system will deny access to those files. Upon selecting the correct patient, the application will provide a list of all patient files that the authorized user has been granted authority to view. The user may then select a file to view. After viewing the file, the user may close the file and return to the list to view another file.

It is understood that versions of the invention are embodied in different forms and combinations of software and hardware. Nonetheless, at least two versions of the apparatus are disclosed. One version for Apple iOS operating system, and one version for Google's Android operating system, are disclosed. It is understood that other versions of the invention may be used with different operating systems. It is preferred that the devices used for interfacing with the system have WiFi or cellular internet connectivity.

It will be readily understood to those skilled in the art that various other changes in the details, material, and arrangements of the parts and method stages which have been described and illustrated in order to explain the nature of this inventive subject matter can be made without departing from the principles and scope of the inventive subject matter.

What is claimed is:

1. A data management system for managing patient information and distributing said information to a plurality of authorized users, said system comprising:
a. a plurality of computing devices each having computer executable code thereon, said code configured for managing patient information and controlling access to said patient information;
b. at least one data management server in electronic communication with said plurality of computing devices via an electronic communications network; and
c. at least one database in electronic communication with said at least one data management server, said at least one database storing a plurality of patient files, each of said files containing patient information associated with a particular patient,
said computer executable code comprising a means for one or more administrators to manage patient information and to control access to said patient information, said access granted to a plurality of authorized users,
said computer executable code further comprising a means for said plurality of authorized users to access administrator-selected patient information, and a means for said one or more administrators to control access to said patient information by each of said authorized users.

2. The data management system of claim 1, wherein said computer executable code further comprises a means for each authorized user to access said server by inputting a code and user-identifying information.

3. The data management system of claim 1, wherein said means for managing patient information comprises a means for creating new patient files by inputting patient information and for editing existing patient files by adding, deleting, or changing patient information contained in said existing files.

4. The electronic portfolio management system of claim 1, wherein said means for controlling access to said patient files comprises a means for restricting viewing to administrator-selected portions of said patient information by administrator-selected authorized users.

5. The data management system of claim 1, wherein said computer executable code further comprises a means for sending communications between one or more administrators and between one or more administrators and one or more authorized users.

6. A computer-implemented method for managing patient information and distributing said information to a plurality of authorized users, said method comprising the steps of:
a. identifying one or more administrators and one or more authorized users;
b. establishing an account for each of said authorized users;
c. providing a plurality of computing devices that communicate with each of said authorized users, each computing device having computer executable code thereon, said code comprising a means for said one or more administrators to manage patient information and to control access to said patient information, said access granted to a plurality of authorized users, said code further comprising a means for each of said authorized users to access administrator-selected patient information, and a means for said one or more administrators to control access to said patient information by each of said authorized users;
d. providing at least one data management server in electronic communication with each of said plurality of computing devices, each server being in electronic communication with at least one database, each database configured to host a plurality of electronic patient files, each of said patient files containing patient information associated with a particular patient;
e. allowing each of said administrators to manage patient information, and allowing each of said administrators to control access to said patient information by each of said authorized users; and
f. allowing each of said authorized users to access administrator-selected patient information.

7. The method of claim 6, further comprising the step of verifying the identity of each of said authorized users.

8. The method of claim 7, wherein the identity of each of said authorized users is identified by each authorized user inputting a code and user-identifying information.

9. The method of claim 6, wherein the step of allowing each of said administrators to manage patient information comprises allowing each administrator to create new patient files by inputting patient information and to edit existing patient files by adding, deleting, or changing patient information contained in said existing files.

10. The method of claim 6, wherein the step of allowing each of said administrators to control access to said patient information by said authorized users comprises allowing an administrator to restrict viewing to administrator-selected portions of said patient information by administrator-selected authorized users.

11. The method of claim 6, wherein said computer executable code further comprises a means for sending communications between one or more administrators and between one or more administrators and one or more authorized users.

12. A non-transient computer-readable medium containing program instructions configured for causing a computer system to perform a method comprising:
a. establishing an account for each of a plurality of authorized users;
b. verifying the identity of each of said authorized users;
c. allowing one or more administrators to manage patient information;
d. allowing each of said administrators to control access to said patient information by each of said authorized users;
e. allowing each of said authorized users to access administrator-selected patient information.

13. The computer-readable medium of claim 12, wherein the computer system further performs the step of verifying the identity of each of said authorized users.

14. The computer-readable medium of claim 13, wherein the identity of each of said authorized users is identified by each authorized user inputting a code and user-identifying information.

15. The computer-readable medium of claim 12, wherein the step of allowing each of said administrators to manage patient information comprises allowing each administrator to create new patient files by inputting patient information and to edit existing patient files by adding, deleting, or changing patient information contained in said existing files.

16. The computer-readable medium of claim 12, wherein the step of allowing each of said administrators to control access to said patient information by said authorized users comprises allowing an administrator to restrict viewing to administrator-selected portions of said patient information by administrator-selected authorized users.

17. The computer-readable medium of claim 12, wherein said method further comprises the step of providing a means for sending communications between one or more administrators and between one or more administrators and one or more authorized users.
